(19) United States
(12) Patent Application Publication
(10) Pub. No.: US 2012/0026084 A1
(43) Pub. Date: Feb. 2, 2012

(54) SIGNALING DEVICE POSITION DETERMINATION

(76) Inventor: Bradley N. Suggs, Sunnyvale, CA (US)

(21) Appl. No.: 13/260,341

(22) PCT Filed: Mar. 31, 2009
(86) PCT No.: PCT/US2009/039030

§ 371 Date: Sep. 25, 2011

(51) Int. Cl. G06F 3/03

(52) U.S. Cl. 345/156

(57) ABSTRACT

A system and method for providing user input to a device. A system includes a light source, a user positioned signaling device, an image capture device, and an image processor. The user positioned signaling device includes a retroreflective structure and a polarization retarder. The image capture device captures images of the signaling device. The image processor processes the captured images and determines a position of the signaling device based, at least in part, on light polarized and reflected by the signaling device.

### BACKGROUND

Over the years, user interface systems of various types have been developed to facilitate control of computers and other electronic devices. Simple switches and knobs suffice to provide operator input information to some electronic devices. Computer based systems, on the other hand, have generally employed more flexible data and control input means. Keyboard entry prevails in the command line environment. Pointing devices, such as mice, trackballs, touchpads, joysticks, etc. rose to prominence with the rise of graphical user interfaces. Touch screen technologies allow the surface or near surface of a display to serve as a user interface device. Some user input systems employ hand-held accelerometers to detect user motion and wirelessly transmit motion information to a computing system.

### BRIEF DESCRIPTION OF THE DRAWINGS

For a detailed description of exemplary embodiments of the invention, reference will now be made to the accompanying drawings in which:

FIG. 1 shows a system that includes a gesture based control system in accordance with various embodiments;

FIG. 2 shows a handheld signaling device used with a gesture based control system in accordance with various embodiments;

FIG. 3 shows exemplary determination of location and orientation of a signaling device using projection distributions in accordance with various embodiments;

FIG. 4 shows parameters related to determining the orientation of a signaling device in accordance with various embodiments;

FIG. 5 shows a gesture based control system in accordance with various embodiments; and

FIG. 6 shows a flow diagram for a method for gesture-based control in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A user control system for computers or other electronic systems is disclosed herein. Control devices employing accelerometers or other types of motion sensors, and that wirelessly transmit motion information to a computing device allow for application of a wide range of user motion to computer based device control. Unfortunately, such control devices can be costly due to the required motion sensors and radio frequency electronics. Moreover, such control devices are generally battery powered, and recharging and/or replacing the batteries can be inconvenient. Embodiments of the present disclosure employ a machine vision system and a passive signaling device tuned for detection by the vision system to monitor operator movements. Detected operator movements can be identified as gestures and the gestures applied to control an electronic system.

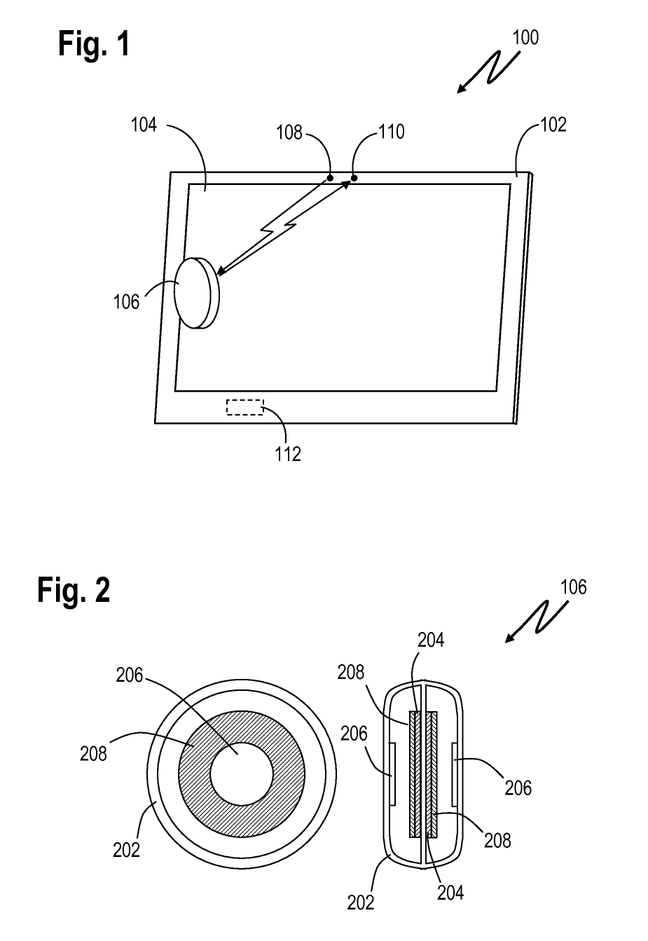

FIG. 1 shows a system 100 that includes a gesture based control system in accordance with various embodiments. The exemplary system 100 is illustrated as a display device 102 including a display screen 104 that provides information to a user. As a matter of convenience, various components of the control system are illustrated as being incorporated into the display 102, in practice however, control system components may be separate from the display 102. The control system includes an illumination device 108, an image capture device 110, an image processor 112, and a user operated signaling device 106.

The illumination device 108 provides light for operation of the vision system. In some embodiments, the illumination device 108 provides infrared or other invisible radiation to avoid visible light that may be objectionable to a user. Various light producing devices, for example light emitting diodes (“LEDs”) (e.g., infrared LEDs), may be used. The illumination device 108 can emit light at a sufficient solid angle to illuminate the field of view of the image capture device 110. The illumination intensity provided by the illumination device 108 is high enough to provide a return signal detectable by the image capture device 110 with the signaling device 108 at its furthest operational distance from the image capture device 110 while the intensity is low enough to meet acceptable safety exposure limits.

The image capture device 110 is configured to detect light in the wavelengths produced by the illumination device 108 and to capture images at a rate and resolution suitable for accurate detection of the signaling device 106 and its movement. The image capture device 110 includes a lens for focusing light on an image sensor. The image sensor can comprise an array of photodetectors whose combined output composes a video frame. The image sensor can be a charge coupled device, a complementary metal oxide semiconductor image sensor, or any other image sensing technology. In some embodiments, the image capture device 110 includes a filter to reduce the amplitude of light wavelengths not produced by the illumination device 108, for example, a visible light filter. Some embodiments include a polarizer configured to pass light of the polarity reflected by the signaling device 106. Some embodiments of the image capture device 110 can operate with either visible light or light provided by the illumination device 108 by allowing selection of an infrared filter, or visible light filter, and/or polarizer.

The image capture device may operate at any of a variety of resolutions and/or frame rates. In some embodiments, a resolution of 640×480 pixels and/or a frame rate of 30 frames per second may be used, but no particular resolution or frame rate is required. In some embodiments, the image capture device comprises a “webcam” without an infrared attenuation filter.

The signaling device 106 reflects light produced by the illuminating device 108 for detection by the image capture device 110. The signaling device 106 is passive, thus reducing the cost of the control system, and eliminating the need for batteries, recharging, etc. FIG. 2 shows a handheld signaling device 106 used with a gesture based control system in accordance with various embodiments. The signaling device comprises a structural substrate 202 that is transparent to the light wavelengths produced by the illumination device 108. For example, strain free acrylic may be used for the structural substrate 202 in some embodiments.

To provide unambiguous detection of the passive signaling device 106, the device 106 possesses visual characteristics unlikely to be replicated in the environment of its intended use. One such characteristic is retroreflectivity. The signaling device 106 includes a retroreflective structure 204 for reflecting light. Any retroreflective film, sheeting, or other retroreflective structure can be used. To further differentiate the signaling device 106 from its operation environment, some embodiments of the signaling device 106 include a polarization retarder 208 over the retroreflective structure 204. The polarization retarder 208 in combination with the retroreflective structure 204 makes the characteristics of the signaling device 106 unlikely to be unintentionally duplicated.

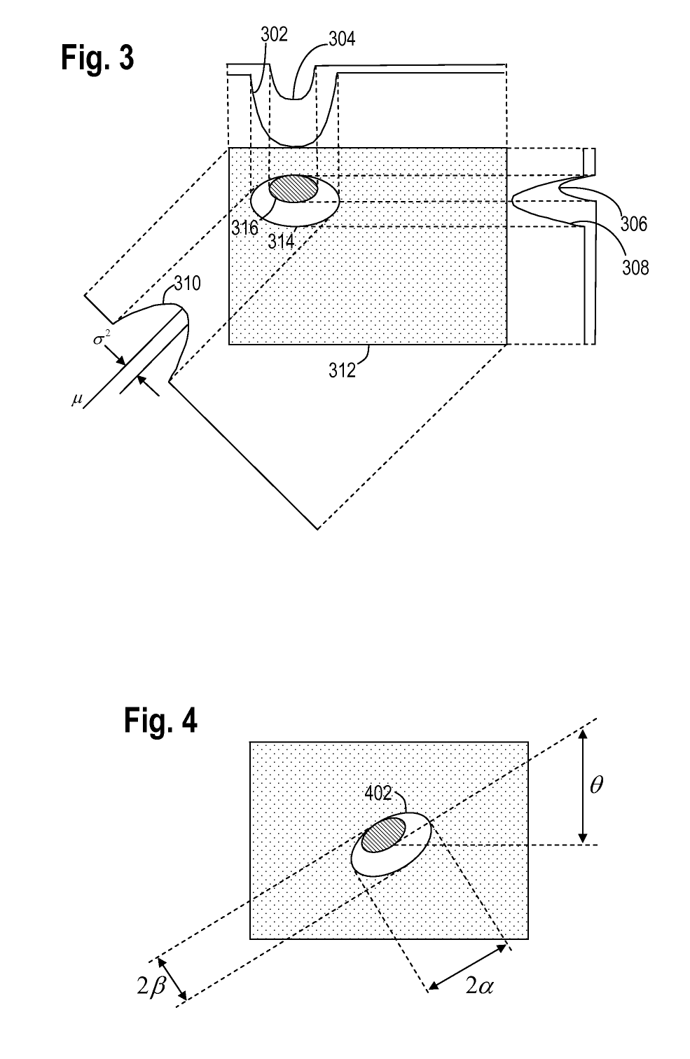

The signaling device 106 is configured to enable determination of its position in three dimensions, and its orientation along two axes. The disk shape of the device 106 provides these attributes with the exception that an elliptical image of a circle tipped in one direction cannot be distinguished from an elliptical image of the circle tipped by the same amount in the opposite direction. The length of the major axis of the ellipse allows a determination of the distance from the signaling device 106 to the image capture device 110. To resolve the angular ambiguity, embodiments of the signaling device 106 include an absorptive structure 206, depicted here as an absorptive disk, but no particular shape is required. The absorptive disk 206 can be opaque or semitransparent. For example, in some embodiments the absorptive disk 206 may pass approximately 70% of the light received from the illumination device 108. The absorptive disk 206 can be of a smaller diameter than the retroreflective structure 204. The absorptive disk 206 creates an area of lessened illumination (i.e., a shadow) that can be detected to determine the angular orientation of the signaling device 106. FIG. 3 shows an example of a video frame 312 including an image of the signaling device 106 with the top of the device tipped back. An elliptical shadow 316 created by the absorptive disk 206 is in the upper half of the ellipse 314 created by the retroreflective disk 204. The position of the shadow 316 can be used to determine the orientation of the signaling device 106.

The signaling device 106 can be further discriminated from its background by reducing the signal produced by light sources other than the illumination device 108. Some embodiments provide such discrimination by subtracting an image captured with the illumination device 108 inactive from an image captured with the illumination device 108 active. For example, with an image capture device 110 capable of capturing thirty images per second, activation of the illumination device 108 can be synchronized with image capture, such that the illumination device 108 is activated only on alternate frames (i.e., 15 times per second). Thus, frame 1 can be captured with the illumination device 108 inactive, and frame 2 captured with the illumination device 108 active. Frame 1 can then be subtracted from frame 2 to eliminate unwanted signals.

In addition to, or in lieu of, the discrimination method described above, some embodiments can change the polarization of emitted or received light (e.g., on alternate frames) to identify image signals produced by light sources other than the illumination device 108. An embodiment using such changing polarization can include an illumination device 108 that is linear polarized, a linear polarizer positioned in front of the illumination device 108, and/or a linear polarizer disposed as a polarization analyzer for the image capture device 110. An electro-optic polarization rotator (e.g., a twisted nematic cell) can be disposed in front of either the illumination device 108 or the image capture device 110 to change the polarization of emitted or captured light.

For example, with an electro-optic polarization rotator disposed at the illumination device 108, right hand circularly polarized light can be emitted with the polarization rotator energized. The right hand circularly polarized light is returned through the signaling device 106 to emerge as right hand circularly polarized and passed through a right hand circular analyzer to be detected by the image capture device 110. With the polarization rotator not energized, left hand circularly polarized light can be emitted and returned to be blocked by the right hand circular analyzer. With this discrimination method, the retroreflective material 204 of the signaling device 106 can possess the polarization characteristics of a single specular reflection. Accordingly, some embodiments can employ a cat's eye type material rather than a corner cube type material for the retroreflective structure 204, and the polarization retarder 208 may be equivalent to a quarter-wave retarder.

Embodiments further reduce unwanted signals by restricting the light wavelengths produced by the illumination device 108 and providing detection wavelength sensitivity. Spectrum reduction is achieved by employing a narrow spectrum light source such as an LED for the illumination device 108. Detection wavelength sensitivity can be obtained by including a band-pass filter tailored to the spectrum of interest. The band-pass filter can be implemented in the image capture device 110 and/or in the image processor 112.

The image processor 112 obtains video frames (i.e., images) produced by the image capture device 110 and processes the images to determine a position and orientation of the signaling device 106. The image processor 112 can be implemented as a processor, for example, a general purpose processor, digital signal processor, microcontroller, etc. and software programming that when executed causes the processor to perform the various functions described herein, such as filtering images, determining position and orientation, and providing position and orientation information to a gesture recognition or application module. Software programming is stored in a computer readable medium, such as semiconductor memory, magnetic storage, optical storage, etc. Embodiments can implement at least some of the image processor 112 in dedicated hardware, a combination of dedicated hardware and a processor executing software programming, or solely as software programming executed by a processor.

FIG. 3 shows exemplary determination of location and orientation of a signaling device 106 using projection distributions in accordance with various embodiments. The image processor 112 receives video images from the image capture device 110. The image data may be in, for example, YUY2 format. At least some embodiments may use only the luminance portion of the image data.

Embodiments use projection distributions to determine the location and orientation of the signaling device 106 in the frame 312. Horizontal distributions 302, 304, vertical distributions 306, 308, and diagonal distributions 310 are computed by the image processor 106. The distributions can be simultaneously constructed. Each pixel of the frame 312 can be accessed once, and if the pixel value (e.g., luminance) exceeds a first predetermined threshold, a corresponding element in each of three distribution arrays 302, 308, 310 is incremented. The first predetermined threshold represents a minimum level of illumination reflected by the retroreflective structure 204 of the signaling device 106 for detection. If the pixel value is also less that a second predetermined threshold, a corresponding element in each of two other distribution arrays 304, 306 is incremented. The second predetermined threshold represents a maximum level of illumination attributable to light passing through the absorptive disk 206 of the signaling device 106. Thus, the distributions 302, 308, 310 represent light reflected by the retroreflective structure 204, while distributions 304 and 306 represent light attenuated by the absorptive disk 206.

The image processor 112 further processes each of the distribution arrays as a distribution to obtain a mean (μ) and a variance (σ²) for the direction and luminance represented by the array. At least some embodiments use only seven of the ten mean/variance results. Such embodiments do not use the mean of the diagonal distribution 310 or the variance of either dim region distribution 304, 306. The seven values (means of 302, 304, 306, 308, and variances of 302, 308, 310), in conjunction with knowledge of the lens viewing angle describe the relationship of the signaling device 106 to the image capture device 110.

The means of the vertical distribution 308 and the horizontal distribution 302 combine to identify the center of the bright ellipse 314 representing the retroreflector 204. Similarly, the means of the vertical distribution 306 and the horizontal distribution 304 combine to identify the center of the dim ellipse 314 representing the absorptive disk 206. The relationship of these two centers can be used to resolve the ambiguity of the angular orientation of the signaling device 106.

For descriptive purposes, the distributions 302, 308, and 310 are respectively referred to below as BrightHoriz, BrightVert, and BrightDiag. As disclosed above, the center of the signaling device 106 is identified by the means of the BrightHoriz and BrightVert distributions. Thus,

x=μ_{BrightHoriz},and (1)

y=μBrightVert. (2)

FIG. 4 illustrates signaling device orientation determinations in accordance with various embodiments. The variances of the distributions 302, 308, 310 are applied as follows.

γ_{Bright}=σ_{BrightHoriz}²−σ_{BrightVert}²,and (3)

δ_{Bright}=σ_{BrightDiag}²−σ_{BrightHoriz}²−σ_{BrightVert}² (4)

are intermediate values included to simplify the following equations.

$${θ}_{Bright} = \frac{1}{2} {tan}^{- 1} ( \frac{{δ}_{Bright}}{{γ}_{Bright}} ) \qquad ( 5 )$$

defines the angle formed by the major axis of the ellipse 402, and horizontal.

$${α}_{Bright} = \sqrt{( 2 ( {γ}_{Bright} + \sqrt{( {δ}_{Bright}^{2} + {γ}_{Bright}^{2} )} ) )} \qquad ( 6 )$$

where 2α defines the length of the major axis of the ellipse 402.

$${β}_{Bright} = \sqrt{( 2 ( {γ}_{Bright} - \sqrt{( {δ}_{Bright}^{2} + {γ}_{Bright}^{2} )} ) )} \qquad ( 7 )$$

where 2β defines the length of the minor axis of the ellipse 402.
Knowing that the length of the ellipse's major axis is the same as the diameter of the retroreflective structure 204 enables the image processor 112 to determine the distance from the image capture device 110 to the signaling device 106. The tilt angle with respect to the axis between the signaling device 106 and the image capture device 110 is the cosine of the ratio of the ellipse's minor to major axis,

$$cos ( \frac{2 β}{2 α} ) .$$

The tilt angle can be resolved into horizontal and vertical components by the ellipse's orientation (θ) to determine the position and rotation of the signaling device 106.

The image processor 112 provides signaling device 106 location and orientation information, for example x, y, α, β, and θ as defined above, to system software (e.g., a gesture recognizer or other application) to enable user control of the system. In some embodiments, a graphical representation of the signaling device 106 as seen by the image capture device 110 (i.e., a cursor) duplicates the movement and/or the orientation of the signaling device 106 on display 104. In some embodiments, only the horizontal and vertical position of the signaling device 106 is used to move a cursor on display 104 with a total excursion that remains constant with distance. In other embodiments, a cursor can be controlled through the horizontal and vertical tilt angles of the signaling device 106. Embodiments interpret the movement and/or tilt angle of the signaling device 106 to identify gestures used to control the system 100.

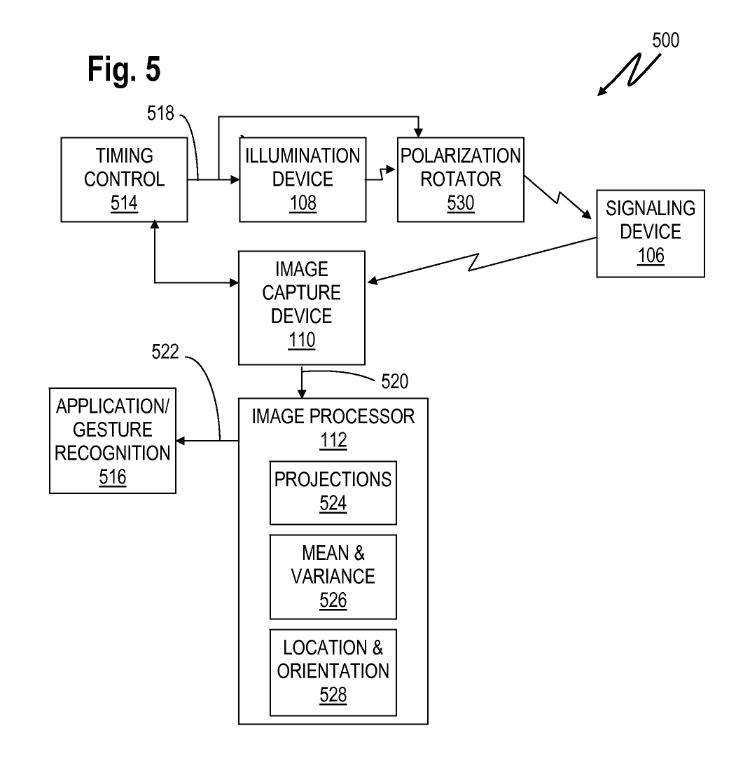

FIG. 5 shows a gesture based control system 500 in accordance with various embodiments. The system comprises a signaling device 106, an illumination device 108, an image capture device 110, and an image processor 112 as described above. The illumination device 108 provides light invisible to, or minimally visible to, a user. The image capture device 110 acquires images of the signaling device 106 reflecting the light. The image processor 112 processes the images to determine the location and orientation of the signaling device.

The gesture based control system 500 also includes a timing control module 514 and an application/gesture recognition module 516. The timing control module provides a control signal 518 to synchronize activation of the illumination device 108 or a polarization retarder device with image acquisition by the image capture device 110. As described above, some embodiments can deactivate the illumination device 108 or an electro-optic polarization rotator 530 on, for example, alternate image acquisitions to allow for acquisition of images in ambient or alternate polarization light. These image signals can be subtracted from images acquired with the illumination device 108 or the electro-optic polarization rotator 530 activated to allow removal of image data related to lighting provided by sources other than the illumination device 108 or not reflected from the signaling device 106. In some embodiments, synchronization timing is determined by the image capture device 110, or the timing control module 514 can control the timing of both the illumination device 108 or electro-optic polarization rotator 530 and the image capture device 110. Embodiments are not limited to any particular method of synchronizing illumination or polarization rotation with image capture. Various embodiments can use either the activated or the inactivated state of the electro-optic polarization rotator 530 to detect unwanted image data.

The image processor 112 includes a projections module 524, a mean and variance computation module 526, and a location and orientation module 528. The image capture device 110 provides digitized image data 520 to the image processor 112. The projections module 524 derives horizontal, vertical, and diagonal projection distributions from the image data 520 as described above. The mean and variance module 526 processes the distributions to determine the mean and variance values for each. The location and orientation module 528 uses the mean and variance values to determine location and/or orientation parameters 522 for the signaling device 106.

The application/gesture recognition module 516 uses the location and/or orientation parameters 522 to control the system 500. For example, the application/gesture recognition module 516 can identify the location of the signaling device 106 relative to items shown on a system display and/or identify movements of the signaling device 106 as gestures that are defined as control input to the system 500 (e.g., to select an operation to perform).

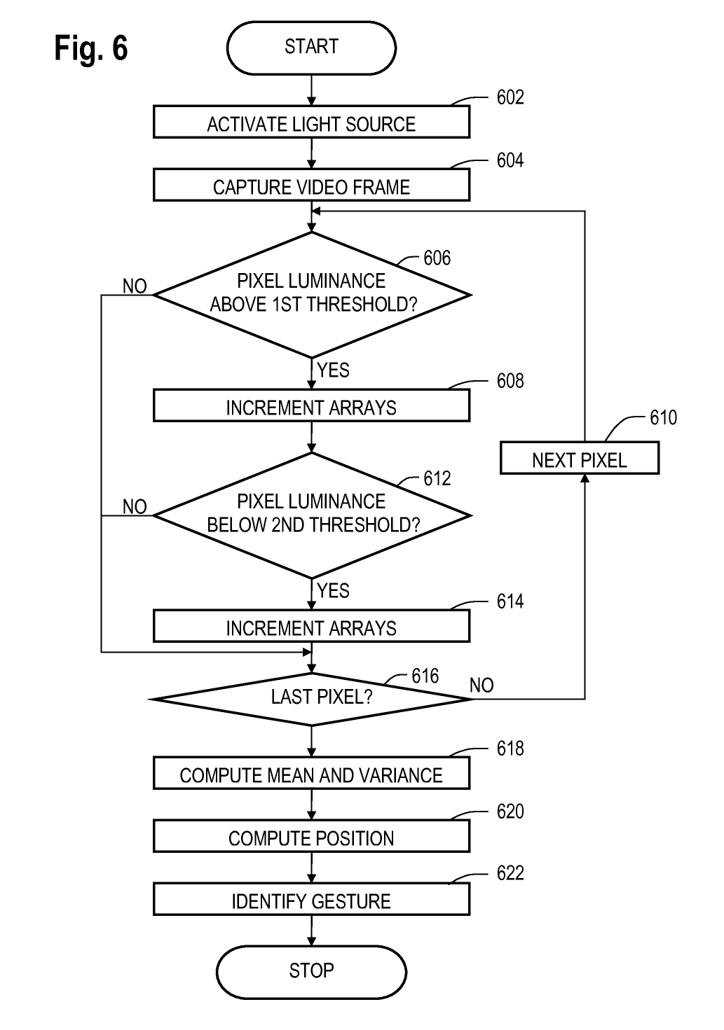

FIG. 6 shows a flow diagram for a method for implementing a gesture based edit mode applicable to a variety of applications in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method, for example, the operations performed by the image processor 112, can be encoded in instructions provided to a processor as software programming.

In block 602, a light source 108 is activated. The light source 108 may be continually active, or intermittently active. In some embodiments, the light source 108 is activated on alternate image acquisitions to allow image signals related to ambient light to be subtracted from images acquired when the light source 108 is active. The light source 108 may be, for example, an infrared LED.

In block 604, an image is acquired by capturing a video frame. In some embodiments, frame capture is synchronized with light source activation to allow control of whether the light source 108 is active during frame capture. Some embodiments synchronize polarization rotation with frame capture. In some embodiments, the image acquired will be largely in the near infrared portion of the spectrum. The image capture device 110 used to capture the frame can be any of a wide variety of video cameras. Some embodiments of the image capture device 110 are configured with filters to facilitate capture of near infrared images.

In block 606, a video frame is provided to the image processor 112. The image processor 112 reads a pixel from the frame and compares the pixel value (e.g., pixel luminance) to a threshold set to identify light reflected by the retroreflector 204 of the signaling device 106. If the pixel luminance is greater than (or equal to in some embodiments) the threshold, then a corresponding element in each of three distribution arrays is incremented in block 608. The three arrays represent horizontal, vertical, and diagonal distributions 302, 308, 310 of retroreflector 204 illumination. If the pixel luminance is less than the threshold, no retroreflector 204 illumination is indicated and pixel evaluation continues in block 616.

In block 612, the image processor 112 compares the pixel luminance to a second threshold. The second threshold is set to discriminate light reflected directly from the retroreflector 204 from light passing through the absorptive disk 206 (i.e., set to identify the shadow region 316). If the pixel luminance is below the threshold, then the pixel is in the shadow 316, and an element corresponding to the pixel in each of two other distribution arrays is incremented in block 614. The two arrays represent horizontal and vertical distributions 304, 306 of the shadow region 316. If the pixel luminance is not less than the threshold, no shadow region 316 is indicated and pixel evaluation continues in block 616.

If, in block 616, the last pixel of the frame has been processed, then processing continues in block 618. Otherwise, the next pixel is selected for processing in block 610, and threshold comparisons are performed beginning in block 606.

When the projection distributions for the frame have been constructed, the image processor 112 computes a mean and variance for each of the five distribution arrays in block 618. In some embodiments, the means of the horizontal and vertical distributions 302, 304, 306, 308 are computed and the variances of the bright region distributions 302, 308, and 310 are computed.

In block 620, the image processor 112 uses the means and variances to compute the position of the signaling device 106. The location of the signaling device in three dimensions is computed. Additionally, the orientation of the signaling device in two dimensions is computed. In some embodiments, the location and orientation of the signaling device 106 are determined as disclosed above in equations (1)-(7) and associated text.

In block 622, the location and orientation of the signaling device are used to identify a gesture. The gesture is defined by movement of the signaling device 106, and signifies a user requested system operation. In at least some embodiments, a cursor on a system display 104 is moved in accordance with the determined location and/or orientation of the signaling device 106.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
a light source;
a user positioned signaling device comprising a retroreflective structure and a polarization retarder;
an image capture device that captures images of the signaling device; and
an image processor that processes the captured images and determines a position of the signaling device based, at least in part, on light polarized and reflected by the signaling device.

2. The system of claim 1, wherein the image processor determines a set of projection distributions for the image and determines a location and an orientation of the signaling device based, at least in part, on the distributions.

3. The system of claim 1, wherein the image capture device is tuned to detect light at wavelengths produced by the light source.

4. The system of claim 1, wherein one of activation of the light source and polarization of light emitted by the light source through an electro-optic polarization rotator is synchronized with image capture by the image capture device, and the one of the light source and the electro-optic polarization rotator synchronized with image capture is activated on alternate image captures.

5. The system of claim 1, wherein the signaling device is passive, and further comprises an absorptive structure disposed between the light source and the retroreflective structure.

6. A method, comprising:
illuminating a passive retroreflective device with a light source that produces light invisible to a user of the device;
capturing an image of the retroreflective device; and
processing the image to produce a computer control signal indicative of user movements.

7. The method of claim 6, further comprising capturing a set of successive images of the retroreflective device, and illuminating the retroreflective device with light invisible to the user only during alternate image captures.

8. The method of claim 6, further comprising determining vertical, horizontal, and diagonal projection distributions for the image.

9. The method of claim 8, further comprising determining a location and an orientation of the retroreflective device based on the distributions.

10. The method of claim 6, further comprising detecting an area of first reflection intensity in the image and an area of second reflection intensity in the image surrounded by the area of first reflection intensity, wherein a luminance of the area of second reflection intensity is lower than a luminance of the area of first reflection intensity.

11. A computer input device, comprising:
a retroreflective structure; and
a polarization retarder disposed over the retro-reflective structure.

12. The computer input device of claim 11, further comprising a light absorbing structure disposed to cast a shadow on the retroreflective structure when the input device is externally illuminated.

13. The computer input device of claim 11, further comprising a disk shaped structural substrate that is transparent to a selected range of light wavelengths; the retroreflective structure and the polarization retarder are disposed in the substrate.

14. The computer input device of claim 11, further comprising a plurality of retroreflective structures and a plurality of polarization retarders.

15. The computer input device of claim 11, wherein the computer input device is passive, and the polarization structure comprises a quarter wave plate.
